(19) United States
(12) Patent Application Publication
(10) Pub. No.: US 2006/0067043 A1
(43) Pub. Date: Mar. 30, 2006

(54) Merchandise sales data processing apparatus

(75) Inventors: Kazumi Kotani, Shizuoka (JP); Yoshimi Urushibata, Shizuoka (JP); Kazuhiro Fushimi, Shizuoka (JP); Katsumi Gocho, Shizuoka (JP); Norifumi Shishido, Shizuoka (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Toshiba Tec Kabushiki Kaisha, Tokyo (JP)

(21) Appl. No.: 11/230,000

(22) Filed: Sep. 19, 2005

(30) Foreign Application Priority Data
Sep. 27, 2004 (JP) P2004-279877

(51) Int. Cl. G06F 1/16

(52) U.S. Cl. 361/685

(57) ABSTRACT

In a hard disk drive unit having a hard disk drive, the hard disk drive is held by a reinforcing member for reinforcing the rigidity of a housing of the hard disk drive, and a supporter elastically supports the reinforcing member to elastically support the hard disk drive. The supporting member is adapted to support the hard disk drive while outside of a housing of a merchandise sales data processing apparatus.

### CROSS-REFERENCE TO RELATED APPLICATION

The present application is based on and claims the benefit of the priority of Japanese Patent Application P2004-279877 filed on Sep. 27, 2004, the entire contents of which are incorporated herein by reference.

### BACKGROUND OF THE INVENTION

1. Field of the Invention

The present invention relates to a merchandise sales data processing apparatus.

2. Description of Related Art

Merchandise sales data processing apparatuses such as a POS (a Point Of Sale) terminal containing a hard disk drive (hereinafter HDD), or an ECR (an Electronic Cash Register) are known in the related art.

The HDD has a storage medium (hereinafter a hard disk), which is made of aluminum, for example, and on which a magnetic material is coated, and executes reading/writing of various control programs, and so on, on the hard disk by using a magnetic head. When reading/writing data, the HDD spins the hard disk rapidly and transfers the magnetic head along a radial direction of the hard disk. (See Japanese Laid-Open Publication No. Hei 07-106775 as a reference (hereinafter document 1)).

A structure of the HDD is susceptible to vibration. When a strong external vibration is applied to the HDD while the reading/writing of data is executed, an error may occur in the reading/writing of data. Therefore, a merchandise sales data processing apparatus having a vibration absorption structure in the HDD installation thereof has been proposed.

For the vibration absorption structure, a structure having a vibration absorption rubber between the HDD and a housing of an apparatus body has been proposed. However, this gives rise to another problem that a vibration is caused by the HDD itself due to spinning of the hard disk or transfer of the magnetic head. To be more specific, the housing of the HDD vibrates as the hard disk spins or the magnetic head moves. As a result, the whole HDD would be subject to vibration.

In the merchandise sales data processing apparatus, the HDD is often changed for purposes of version upgrades of various programs, and so on. In this case, if the vibration absorption structure is installed at the housing of the apparatus body of the merchandise sales data processing apparatus, and when the HDD is removed from the apparatus body, the HDD no longer has the vibration absorption function. Thus, a problem may arise that a vibration is applied to the HDD when the HDD is placed on a horizontal surface. Therefore, it is necessary that the vibration absorption structure be installed to the HDD.

Document 1 discloses a technique for installing a structure to the HDD, which prevents an external vibration and a self-vibration. In document 1, the HDD (the HDD main body in document 1) has a weight at an underside thereof, and the HDD is fixed to a fixing member via a vibration absorption rubber to form a HDD unit. Then, the HDD unit is screwed down in a control apparatus unit such as a numerical control apparatus. It is said that in this structure the self-vibration of the HDD can be prevented by the weight, and an effect of the external vibration can be reduced by the vibration absorption rubber.

However, document 1 focuses no attention on vibration of the housing of the HDD. Also, since the HDD having the weight is fixed directly to the vibration absorption rubber, when a vibration occurs in the housing under this situation, a load to the housing becomes bigger. In some instances, the housing may become deformed so that positional relationships of built-in parts may be misaligned, and reliability of the HDD may decrease.

An object of the present invention is to prevent an impairment of the reliability of the HDD in the merchandise sales data processing apparatus when the vibration absorption structure is installed to the HDD, and is attachable to and/or detachable from the housing of the apparatus body.

### SUMMARY OF THE INVENTION

According to the present invention, a merchandise sales data processing apparatus is provided which includes: a housing, a hard disk drive unit removably stored in the housing, and a connection structure for detachably fixing the supporter inside of the housing. The hard disk drive unit includes a hard disk drive having a second housing, a reinforcing member for reinforcing rigidity of the second housing, and a supporter for elastically supporting the reinforcing member to elastically support the hard disk drive and which is adapted to support the hard disk drive while outside of the housing.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram showing a POS terminal of an embodiment of the present invention;

FIG. 2 is an external perspective view showing a control unit;

FIG. 3 is an external perspective view showing the control unit when a front panel is detached;

FIG. 4 is an external perspective view showing the control unit when the front panel and an internal panel are detached;

FIG. 5 is an external perspective view showing the control unit when a hard disk drive unit is removed,

FIG. 6 is a right-side view showing the hard disk drive unit;

FIG. 7 is an exploded side view showing an elastic part.

### DETAILED DESCRIPTION OF THE PREFERRED EMBODIMENTS

An embodiment of the present invention will be described with reference to the drawings.

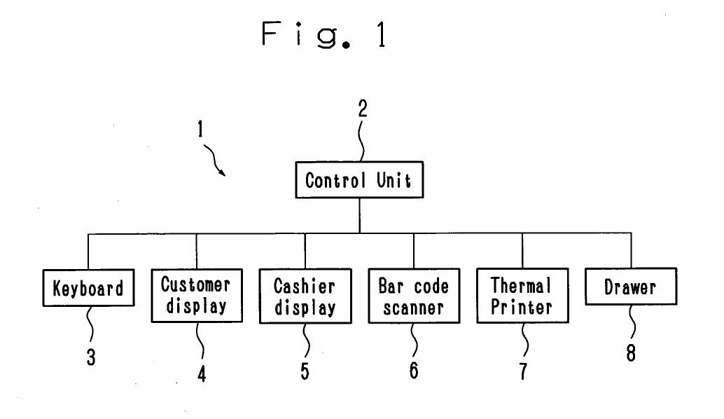

FIG. 1 is a block diagram showing a POS terminal 1 as a merchandise sales data processing apparatus of an embodiment of the present invention. As shown in FIG. 1, the POS terminal 1 has a control unit 2 which connects to a keyboard 3, a customer display 4, a cashier display 5, a bar code scanner 6, a thermal printer 7, and so on. Further, a drawer 8, which is provided separately from the POS terminal, is connected to the apparatus body.

The control unit 2 houses a controller (not shown) for driving and controlling each part. The controller includes a CPU (Central Processing Unit) for intensively controlling each part, which connects to a ROM (Read Only Memory), in which fixed data such as a boot program, and so on, are stored, in advance, a RAM (Random Access Memory), in which various data containing various buffers such as a sales buffer or a printing buffer are rewritably stored, and so on, via bus lines such as an address bus or a data bus. The keyboard 3, the cashier display 5, the customer display 4, the bar code scanner 6, the thermal printer 7, and the drawer 8 are connected to the controller via I/O (not shown).

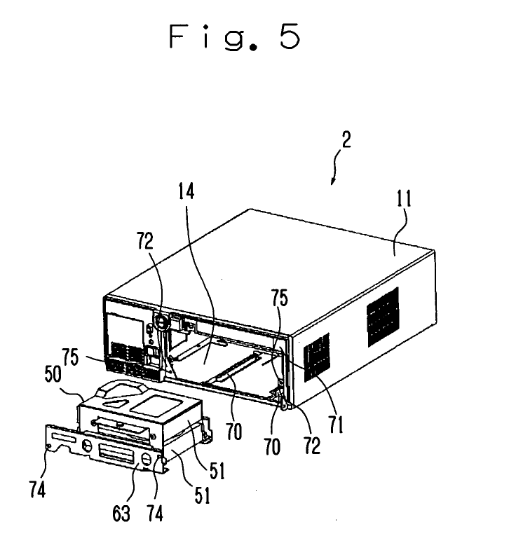

Also, the control unit 2 houses a hard disk drive unit 50 (hereinafter HDD unit 50: see FIG. 5). The HDD unit 50 includes a hard disk drive 51 (hereinafter HDD 51: see FIG. 5). The HDD 51 is a storage device, which executes reading/writing of various data and programs on the hard disk by a magnetic head (not shown). The HDD 51 connects to the controller via I/O (not shown) to operate under the control of the controller. To be specific, the HDD 51 executes the reading/writing on the hard disk by transferring the magnetic head along a radial direction of the rapidly spinning hard disk. The HDD 51 stores a commodity master file, a journal file, and so on, other than computer programs for operating the controller. The commodity maser file stores a commodity name or a unit price corresponding to a commodity code. The journal file stores journal data such as transaction details or sales proceeds, as sales data, which corresponds to a transaction number.

When the POS terminal 1 starts up, the computer program stored in the HDD 51 is run with other various files such as the commodity master file, and so on, so that the controller is ready to drive and control each part.

A processing operation with respect to a sales data processing function relating to a commodity sale will be explained hereinafter. The sales data processing function is executed by the controller. When a commodity code affixed to a commodity is scanned by the bar code scanner 6, for example, the controller searches the commodity master file based on the read commodity code, reads a commodity name or a unit price corresponding to the relevant commodity, and processes a sales registration based on the commodity code, the commodity name, and the unit price. Concurrently, the controller executes a departmental registration, displays on the customer display 4 or the cashier display 5, prints via the thermal printer 7, and accumulates the registered sales registration data to a sales file.

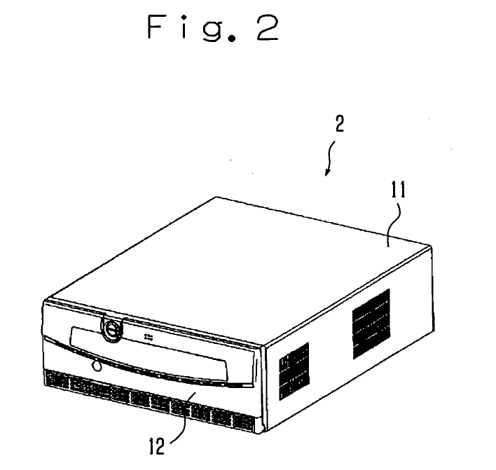

The control unit 2, the distinctive portion of the embodiment of the present invention, will now be described with reference to FIGS. 2 to 7.

FIG. 2 is an external perspective view showing the control unit 2. As shown in FIG. 2, the control unit 2 has a rectangular solid housing 11. Inside the housing 11, the controller, the HDD unit 50, and so on, are contained. A front panel 12 is detachably attached to a front part of the housing 11.

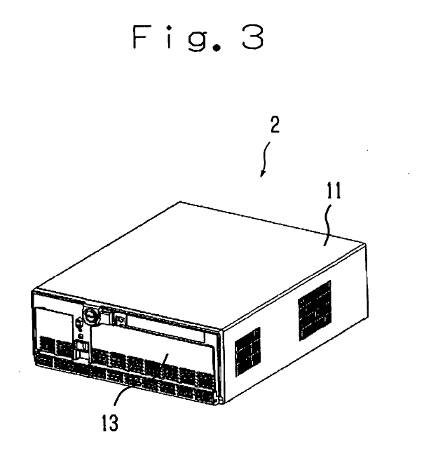

FIG. 3 is an external perspective view showing the control unit 2 when the front panel 12 is detached. As shown in FIG. 3, an internal panel 13 is detachably attached to an inside of the front panel 12 at the front part of the housing 11.

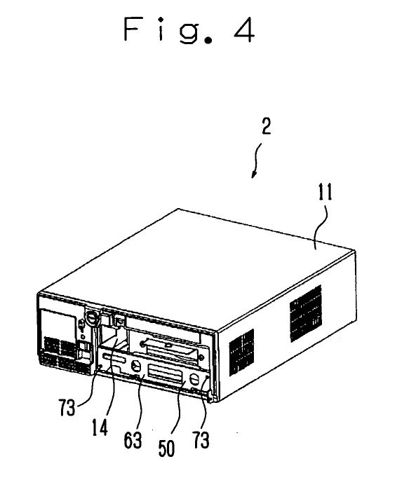

FIG. 4 is an external perspective view showing the control unit 2 when the front panel 12 and the internal panel 13 are detached, and FIG. 5 is an external perspective view showing the control unit 2 when the HDD unit 50 is removed. As shown in FIG. 4 and FIG. 5, an opening 14 is formed in the housing 11, and is exposed as the front panel 12 and the internal panel 13 are detached from the housing 11. The HDD unit 50 is mounted in the opening 14. The HDD unit 50 is exposed as the front panel 12 and the inner panel 13 are detached from the housing 11. The HDD unit 50 is detachably mounted on the housing 11. To be specific, the HDD 50 is attachably/detachably movable along a back and forth direction of the opening 14. Thus, attaching/detaching of the HDD unit 50 is possible from the front part of the housing 11.

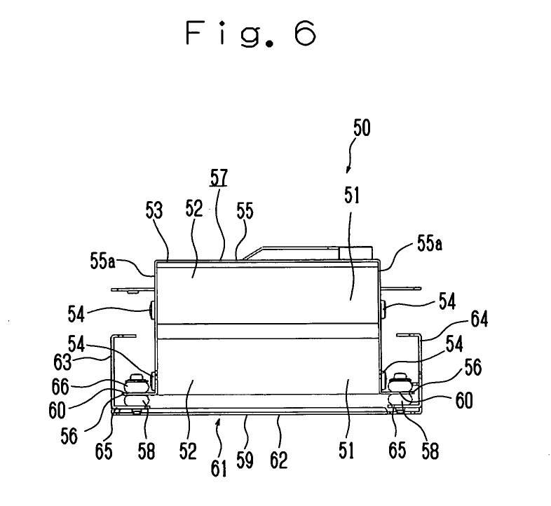

FIG. 6 is a right-side view showing the HDD unit 50. As shown in FIG. 6, the HDD unit 50 contains two HDDs 51. These HDDs 51 have respective rectangular metal housing 52, in which the hard disks, the magnetic heads, and so on, are contained. These HDDs 51 are fixed to a reinforcing member 53 by screws 54 in such a manner that the HDDs 51 are positioned in two tiers.

The reinforcing member 53 includes a U-shaped part 55 which opens downward, and includes a pair of extension parts 56 which extend horizontally outward from the U-shaped part 55. The reinforcing member 53 is formed by bending of sheet metal. The HDD 51 is placed inside the U-shaped part 55. The reinforcing member 53 integrally holds the two HDDs 51. To be specific, each side part of each HDD 51 faces a side wall 55a of the reinforcing member 53, and is screwed to the side wall 55a by the screws 54. As explained above, the reinforcing member 53 is fixed to the HDD 51, so that the housing 52 of the HDD 51 can be reinforced, and rigidity such as flexural rigidity and torsional rigidity can be improved. Here, the integrated reinforcing member 53 and the two HDDs 51 by the screws 54 make up a HDD part 57.

The HDD part 57 is mounted on a supporting member 59 via elastic parts 58. To be specific, attaching parts 60 formed at the extension parts 56 of the reinforcing member 53 are positioned at every corner of the HDD part 57 and are attached to the supporting member 59 by the elastic part 58. Here, a supporter 61 includes the elastic part 58 and the supporting member 59.

The supporting member 59 is made of sheet metal, and is formed to cover an under side of the lower HDD 51. To be specific, the supporting member 59 includes an under board 62, which is positioned under the HDD 51, and is longer than the HDD part 57 in the back and forth direction (See FIG. 6), a front board 63 and a rear board 64, which extend upwardly at a front end and a rear end of the supporting member 59, and so on. Two attaching parts 65 to which the elastic parts 58 are fixed are provided to the front board 63 and the rear board 64, respectively. Each attaching part 65 is formed by drilling a hole on a board that extends horizontally from the front board 63 or the rear board 64 towards an inner part of the supporting member 59. The rear board 64 is formed narrower than the front board 63 in a widthwise direction of the supporting member 59.

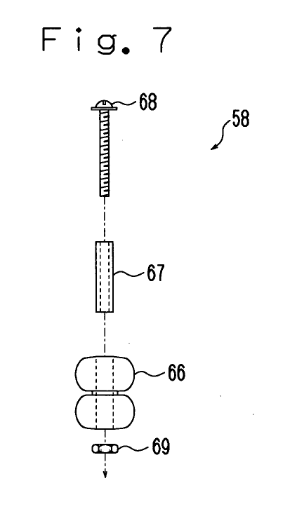

FIG. 7 is an exploded side view showing the elastic part 58. As shown in FIG. 7, the elastic parts 58 contain an elastic member 66 made of rubber having elasticity, a collar 67, a bolt 68, and a nut 69. The elastic member 66 is formed to have a narrowed section between an upper portion and a lower portion thereof. Inside the elastic member 66, a via-hole is formed. The cylindrical collar 67 having both ends open is fit into the via-hole. The collar 67 and the via-hole are designed to have approximately the same length. The elastic part 58 holds the attaching part 60 of the extension part 56 of the reinforcing member 53 at the narrowed part of the elastic member 66. The elastic part 58 is assembled by the bolt 68 being inserted into the collar 67, and by a tip of the bolt 68 being inserted into the hole formed in the attaching part 65 of the supporting member 59 so as to be fixed by the nut 69. The HDD part 57 is thus assembled to the supporting member 59 via the elastic parts 58.

In the HDD unit 50 with the above described structure, the HDD part 57 is elastically supported in the housing 11 by the elastic member 66 of the supporter 61. Further, in a condition that the control unit 2 is removed from the housing 11, the HDD unit 50 can be placed in a manner that the under board 62 faces on the horizontal surface such as on a table. In this case, the HDD part 57 is supported elastically off the horizontal surface by the elastic member 66.

The attaching/detaching of the HDD unit 50 to and from the housing 11 will now be explained. As shown in FIG. 5, a pair of rails 70 is provided extending in the back and forth direction on the bottom surface of the housing 11. The under board 62 of the HDD unit 50 can slidably fit with the pair of rails 70. Further, a plurality of contact parts 72, which a rear surface of the front board 63 of the HDD unit 50 contact, are formed at a front board 71 of the housing 11. These contact parts 72 are formed in a manner that they do not interfere with any part of the HDD unit 50 other than the front board 63 while the HDD unit 50 moves along the pair of rails 70. Therefore, the rear board 64 is pushed into a rear part of the housing 11 when the under board 62 is fit to the pair of rails 70 and moves towards a back end of the housing 11 along the pair of rails 70, and the front board 63 attaches to the attaching parts 72 of the housing 11, so that the HDD unit 50 can be positioned. Additionally, the HDD unit 50 can be detached from the pair of rails 70 by being drawn forward.

As shown in FIG. 4 and FIG. 5, holes 74, through which screws 73 can pass, are formed at right and left ends of the front board 63 of the HDD unit 50, and female screw parts 75 are provided at the contact parts 72 of the front board 71 of the housing 11. When the front board 63 contacts with the contact parts 72 of the housing 11, the screws 73 are screwed into the female parts 75 to fix the HDD unit 50 to the housing 11. When the HDD unit 50 is attached to the housing 11, an electric wire (not shown) of the HDD 51 is connected to an electric wire (now shown) of the housing 11. Consequently, the HDD 51 is connected to the controller and a power section (not shown). An assembly of the control unit 2 can be completed by attaching the internal panel 13 and the front panel 12 to the housing 11 again after the HDD unit 50 is attached to the housing 11.

Meanwhile, when the front panel 12 and the internal panel 13 are detached from the housing 11, and the screws 73 are removed so that the HDD unit 50 can be drawn forward to be removed from the housing 11, the electric wire (not shown) of the HDD 51 and the electric wire (not shown) provided at the housing 11 should be disconnected.

While the HDD unit 50 is attached to the housing 11, when an external vibration applied to the housing 11 is transferred to the HDD unit 50, the vibration is transferred to the elastic parts 58 from the supporting member 59, and is attenuated by the elastic parts 58. Therefore, a direct transference of the vibration applied to the HDD unit 50 via the housing 11 can be prevented. Thus, the impairment of reliability of the HDD 51 can be prevented.

Further, since the housing 52 is reinforced by the reinforcing member 53 to improve rigidity, an occurrence of vibration of the housing 52, which is generated by a spinning of a hard disk or a movement of a magnetic head during the operation of the HDD 51, can be inhibited compared to a known HDD that lacks the reinforcing member 53. Thus, the impairment of reliability of the HDD 51 can be prevented.

Further, since the HDD 51 is fixed to the reinforcing member 53 while the reinforcing member 53 is connected to the elastic parts 58, the reinforcing member 53 does not act as a load to the HDD 51. Thus, the reliability of the HDD 51 can be improved compared to a known HDD unit having a weight attached thereto. Thus, the impairment of reliability of the HDD 51 can be prevented.

Still further, when the HDD unit 50 is detached from the housing 11 for a maintenance reason, and so on, an operator can place the HDD unit 50 in such a manner that the under board 62 lies on a horizontal surface such as on a desk or a floor. In this case, a shock is applied to the HDD unit 50, but the shock may be absorbed by the elastic parts 58 as the shock is transferred from the supporting member 59 to the HDD part 57. Thus, the direct transferring of the shock with the same magnitude as when it affected the supporting member 59, to the HDD part 57 can be prevented. In another words, the shock can be reduced by the function of the elastic part 58 when the HDD unit 50 is placed on the horizontal surface. Consequently, when the HDD unit 50 is placed on the horizontal surface, failure or breaking of the HDD 51 by the shock can be prevented.

Still further, according to the embodiment of the prevent invention, since the reinforcing member 53 is made of sheet metal which holds both sides of the housing 52 such that the reinforcing member and the sides of the housing face each other, the reinforcing member 53 can be realized with a simple structure.

Still further, according to the embodiment of the present invention, at least one portion of the supporter 61 is positioned under the HDD 51, and the supporter 61 can be fixed to and released from the housing 11. In addition, the supporter 61 has the supporting member 59, which can contact a horizontal surface, and the elastic parts 58, whereby the HDD 51 is elastically connected to the supporting member 59 via the reinforcing member 53. Thus, the supporter 61 can be realized with a simple structure.

Yet still further, according to the embodiment of the present invention, since the HDD unit 50 includes a plurality of the HDDs 51, and the reinforcing member 53 integrally holds the plurality of the HDDs 51, the structure can be simplified compared to the related art in which an HDD unit is provided for every HDD 51.

Normally, the housing 11 is located in a place where no obstacle exists in the front of it. Additionally, as a form of usage, the customer display 4, the cashier display 5, the keyboard 3, and so on, may be placed on the top face of the housing 11 of the apparatus body. Thus, in the embodiment of the present invention, when a maintenance or a change of the HDD 51 is necessary, the attaching/detaching of the HDD 51 to and from the housing 11 is easy, since the housing 11 has a structure in which the HDD unit 50 is detachable from the front of the housing 11, and working time for the operation can be shortened compared to a prior art in which the attaching/detaching of the HDD 51 is done from a top face.

Obviously, numerous modifications and variations of the present invention are possible in light of the above teachings. It is therefore to be understood that within the scope of the appended claims, the invention may be practiced otherwise than as specifically described herein.

What is claimed is:

1. A merchandise sales data processing apparatus, comprising:
a housing;
a hard disk drive unit removably stored in the housing, the hard disk drive unit comprising:
at least one hard disk drive including a second housing;
a reinforcing member which reinforces rigidity of the second housing; and
a supporter for elastically supporting the reinforcing member to elastically support the hard disk drive, and which is adapted to support the hard disk drive while outside of the housing; and
a connection structure for detachably fixing the supporter inside of the housing.

2. The merchandise sales data processing apparatus according to claim 1, wherein the reinforcing member is made of sheet metal and holds side parts of the second housing opposite to the reinforcing member.

3. The merchandise sales data processing apparatus according to claim 1, wherein the supporter comprises:
a supporting member including at least one connecting portion which is positioned under the hard disk drive so as to be detachably fixed to the housing, and which is adapted to rest on a horizontal surface; and
an elastic part elastically connects the hard disk drive to the supporting member via the reinforcing member.

4. The merchandise sales data processing apparatus according to claim 2, wherein the supporter comprises:
a supporting member including at least one connecting portion which is positioned under the hard disk drive so as to be detachably fixed to the housing, and which is adapted to rest on a horizontal surface; and
an elastic part elastically connects the hard disk drive to the supporting member via the reinforcing member.

5. The merchandise sales data processing apparatus according to claim 1, wherein at lease one hard disk drive comprises a plurality of the hard disk drives, and the reinforcing member holds the plurality of the hard disk drives integrally.

6. The merchandise sales data processing apparatus according to claim 2, wherein at lease one hard disk drive comprises a plurality of the hard disk drives, and the reinforcing member holds the plurality of the hard disk drives integrally.

7. The merchandise sales data processing apparatus according to claim 3, wherein at lease one hard disk drive comprises a plurality of the hard disk drives, and the reinforcing member holds the plurality of the hard disk drives integrally.

8. The merchandise sales data processing apparatus according to claim 4, wherein at lease one hard disk drive comprises a plurality of the hard disk drives, and the reinforcing member holds the plurality of the hard disk drives integrally.

9. The merchandise sales data processing apparatus according to claim 1, wherein the housing has a structure such that the hard disk drive unit is detachably attachable to a front side of the housing.

10. The merchandise sales data processing apparatus according to claim 2, wherein the housing has a structure such that the hard disk drive unit is detachably attachable to a front side of the housing.

11. The merchandise sales data processing apparatus according to claim 3, wherein the housing has a structure such that the hard disk drive unit is detachably attachable to a front side of the housing.

12. The merchandise sales data processing apparatus according to claim 4, wherein the housing has a structure such that the hard disk drive unit is detachably attachable to a front side of the housing.

13. The merchandise sales data processing apparatus according to claim 5, wherein the housing has a structure such that the hard disk drive unit is detachably attachable to a front side of the housing.

14. The merchandise sales data processing apparatus according to claim 6, wherein the housing has a structure such that the hard disk drive unit is detachably attachable to a front side of the housing.

15. The merchandise sales data processing apparatus according to claim 7, wherein the housing has a structure such that the hard disk drive unit is detachably attachable to a front side of the housing.

16. The merchandise sales data processing apparatus according to claim 8, wherein the housing has a structure such that the hard disk drive unit is detachably attachable to a front side of the housing.
